(19) United States
(12) Patent Application Publication
(10) Pub. No.: US 2025/0101806 A1
(43) Pub. Date: Mar. 27, 2025

(54) CEILING LADDER, DEEP STEP AND METHOD

(71) Applicant: Werner Co., Greenville, PA (US)

(72) Inventors: Steve Woodward, Meadville, PA (US); Shannon Lessner, Madison, WI (US); Thomas Parker, Jamestown, PA (US)

(21) Appl. No.: 18/974,278

(22) Filed: Dec. 9, 2024

Related U.S. Application Data
(63) Continuation of application No. 18/378,588, filed on Oct. 10, 2023, now Pat. No. 12,196,041.
Application No. 18/378,588 is a continuation of application No. 17/564,191, filed on Dec. 28, 2021, now abandoned.
Application No. 17/564,191 is a continuation of application No. 16/746,395, filed on Jan. 17, 2020, now Pat. No. 11,215,010.
Application No. 16/746,395 is a continuation of application No. 15/591,799, filed on May 10, 2017, now Pat. No. 10,538,966.

(51) Int. Cl. E06C 7/08; E04B 9/00; E04F 11/06; E04F 11/104; E04F 11/112; E06C 1/383; E06C 1/393; E06C 7/16

(52) U.S. Cl. CPC E06C 7/08; E04B 9/003; E04F 11/064; E04F 11/104; E04F 11/112; E06C 1/393; E06C 7/165; E06C 1/383

(57) ABSTRACT

A ceiling ladder having a plurality of sections that can be climbed by a user when in an unfolded position into an attic and that can be folded together into a retracted position to be stored above the ceiling. The ladder has a deep step, which has a width greater than the width of other steps of the ladder, in which is located between about 2-5 feet from the floor when the ladder is in the unfolded position so that a user can stand on the deep step and place objects into the attic without having to climb into the attic.

### CROSS-REFERENCE TO RELATED APPLICATIONS

This application is a continuation of U.S. patent application Ser. No. 18/378,588 filed Oct. 10, 2023, which is a continuation of U.S. patent application Ser. No. 17/564,191 filed Dec. 28, 2021, which is a continuation of U.S. patent application Ser. No. 16/746,395 filed Jan. 17, 2020, now U.S. Pat. No. 11,215,010 issued Jan. 4, 2022, which is a continuation of U.S. patent application Ser. No. 15/591,799 filed May 10, 2017, now U.S. Pat. No. 10,538,966 issued Jan. 21, 2020, all of which are incorporated by reference herein.

### FIELD OF THE INVENTION

The present invention is related to a ceiling ladder that has a deep step with a width greater than the width of other steps, ceiling ladder. (As used herein, references to the “present invention” or “invention” relate to exemplary embodiments and not necessarily to every embodiment encompassed by the appended claims.) More specifically, the present invention is related to a ceiling ladder that has a deep step with a width greater than the width of other steps, ceiling ladder where the ladder has a plurality of sections in the sections are able to fold together and be stored above the ceiling without the deep step interfering with the sections when they fold together.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

Ceiling ladders, also called attic ladders or sometimes access ladders, commonly are fixed to the ceiling and extends down from the ceiling so a user can climb the ladder into a room or space above the ceiling, such as an attic. For convenience and efficiency, the ceiling ladders are formed of sections which can be folded together and stored above the ceiling when not needed. There are times when the ladder extends down from the ceiling that the user only climbs part way up the ladder, far enough to simply place objects into the attic without actually having to climb all the way up the ladder into the attic. It would be safer for the user to stand on a step of the ceiling ladder whose width is as large as possible when only partly climbing the ladder to place objects in the attic.

### BRIEF SUMMARY OF THE INVENTION

The present invention pertains to a ceiling ladder. The ladder comprises a frame adapted to fit into the ceiling. The ladder comprises a door that fits into the frame. The ladder comprises a top section fixed to the door having a right top rail, a left top rail in parallel with and opposing the right top rail, and a plurality of top steps having a width attached to the right and left rails. The ladder comprises a second section rotatably attached to the top section having a right second rail, a left second rail in parallel with and opposing the right second rail, and a plurality of second steps attached to the right second rail and the left second rail. At least one of the second steps being a deep step having a width at least 1.5 inches longer than a width of at least another one of the second steps. The right top rail connected by a first hinge to the right second rail and the left top rail connected to the left second rail by a second hinge so the second section can fold onto the top section into a folded position; and unfold from the top section into and unfolded position. The ladder comprises a third section rotatably attached to the second section having a right third rail, a left third rail in parallel with and opposing the right third rail, and a plurality of third steps having a width attached to the right third rail and the left third rail. The right second rail connected by a third hinge to the right third rail and the left second rail connected to the left third rail by a fourth hinge so the third section can fold onto the second section into the folded position and the door can be closed into the frame with the top and second and third sections disposed above the ceiling, and unfold from the second section into the unfolded position. When in the unfolded position, the top and second and third sections align to form the ladder on which a user can climb reach the ceiling with the deep step located 2-5 feet below the ceiling. When in the folded position, the deep step fits between the top steps of the third section.

The present invention pertains to a deep step for a ceiling ladder. The ceiling ladder having a plurality of sections with a top section rotatably attached to the ceiling and a second section rotatably attached to the top section. The second section having a plurality of steps attached to a second right rail and a second left rail of the second section, with the deep step being one of the plurality of steps. The deep step comprises preferably a one-piece extrusion comprising a first flange whose right side is fastened to and inside of a front flange of the second right rail and whose left side is fastened to and inside of a front flange of the second left rail. The one-piece extrusion comprises a front horizontal portion that extends essentially at a right angle from a top of the front flange. The one-piece extrusion comprises a second flange which extends essentially at a right angle down from the front horizontal portion and whose right side is fastened to an inside of a rear flange of the second right rail and whose left side is fastened to an inside of a rear flange of the second left rail. The one-piece extrusion comprises arear horizontal portion that extends from the front horizontal portion in a coplanar manner and from the second flange at essentially a right angle, and between and behind the second right rail and the second left rail, with the rear horizontal portion having a length which is shorter than a length of the front horizontal portion and a length of the second flange.

The present invention pertains to a method for placing objects above a ceiling from a floor. The method comprises unfolding a plurality of sections of a ladder having steps, which is attached to the ceiling, so a user can climb the ladder to above the ceiling from the floor. There is the step of a user climbing the ladder and standing on a deep step of the ladder with an object, which is located between about 2 feet and 5 feet above the floor and below the ceiling. The deep step having a width that is at least 1.5 inches longer than a width of other steps of the ladder. There is the step of the user placing the object above the ceiling while standing on the deep step. There is the step of the user climbing down off the ladder onto the floor. There is the step of the user folding the sections of the ladder together into a retracted position. There is the step of moving the sections of the ladder in the retracted position above the ceiling.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a perspective view of the ceiling ladder of the present invention in an unfolded position.

FIG. 2 is a perspective view of the second section of the ceiling ladder.

FIG. 3 is a side view of the second section.

FIG. 4A is a side view of a normal step.

FIG. 4B is a side view of a deep step.

FIG. 5 is an underside perspective view of the deep step.

FIG. 6 is a perspective view of the ceiling ladder in a folded position.

FIG. 7 is a representation of a user standing on a deep step placing a box above the ceiling

### DETAILED DESCRIPTION OF THE INVENTION

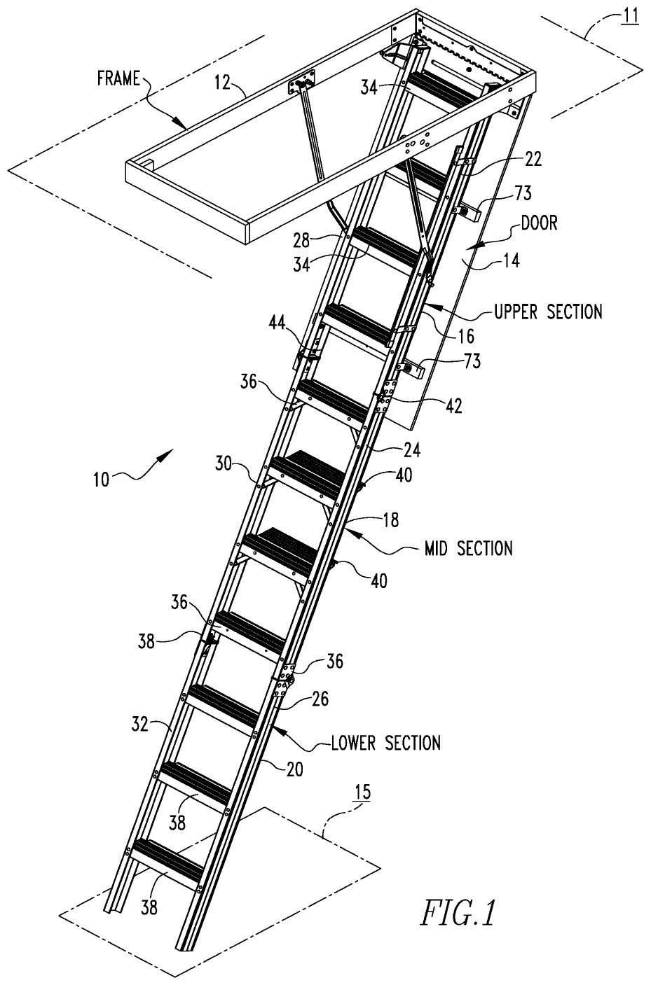

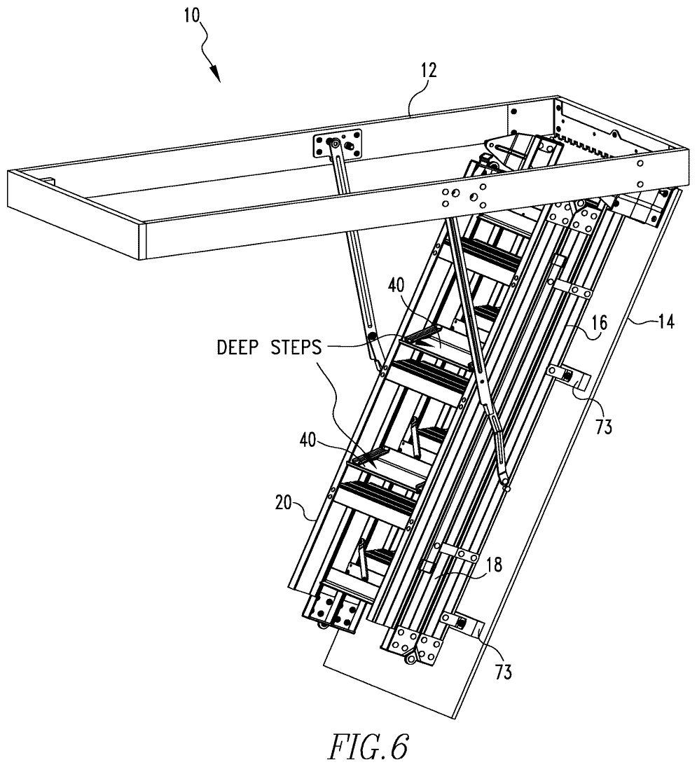

Referring now to the drawings wherein like reference numerals refer to similar or identical parts throughout the several views, and more specifically to FIG. 1 thereof, there is shown a ceiling ladder 10. The ladder 10 comprises a frame 12 adapted to fit into the ceiling 11. The ladder 10 comprises a door 14 that fits into the frame 12. The ladder 10 comprises a top section 16 fixed to the door 14 having a right top rail 22, a left top rail 28 in parallel with and opposing the right top rail 22, and a plurality of top steps 34 having a width attached to the right and left rails. The ladder 10 comprises a second section 18 rotatably attached to the top section 16 having a right second rail 24, a left second rail 30 in parallel with and opposing the right second rail 24, and a plurality of second steps 36 attached to the right second rail 24 and the left second rail 30. At least one of the second steps 36 being a deep step 40 having a width at least 1.5 inches longer than a width of at least another one of the second steps 36. The right top rail 22 connected by a first hinge 42 to the right second rail 24 and the left top rail 28 connected to the left second rail 30 by a second hinge 44 so the second section 18 can fold onto the top section 16 into a folded position; and unfold from the top section 16 into and unfolded position. The ladder 10 comprises a third section 20 rotatably attached to the second section 18 having a right third rail 26, a left third rail 32 in parallel with and opposing the right third rail 26, and a plurality of third steps 38 having a width attached to the right third rail 26 and the left third rail 32. The right second rail 24 connected by a third hinge 46 to the right third rail 26 and the left second rail 30 connected to the left third rail 32 by a fourth hinge 48 so the third section 20 can fold onto the second section 18 into the folded position and the door 14 can be closed into the frame 12 with the top and second and third sections 16, 18, 20 disposed above the ceiling, and unfold from the second section 18 into the unfolded position. When in the unfolded position, the top and second and third sections 16, 18, 20 align to form the ladder 10 on which a user can climb reach the ceiling with the deep step 40 located 2-5 feet below the ceiling. When in the folded position, the deep step 40 fits between the top steps 34 of the third section 20, as shown in FIG. 6.

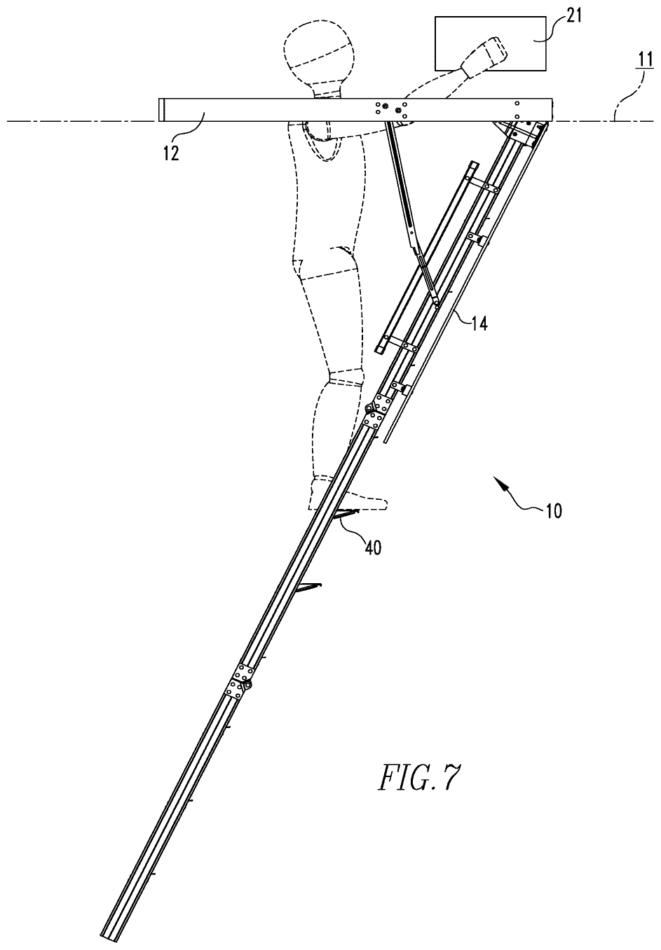

Ceiling or attic ladders have steps which are all the same width (side to side) and the same depth or length (front to rear). These uniform steps are designed to allow the user to simply climb up into and down from an overhead space. But in actual use, often the user will pause when partway up the ladder 10 in order to move objects 21, packages, etc., into and out of the attic, as shown in FIG. 7. Having deeper steps 40 at the height where a user is likely to pause makes standing there safer and more comfortable

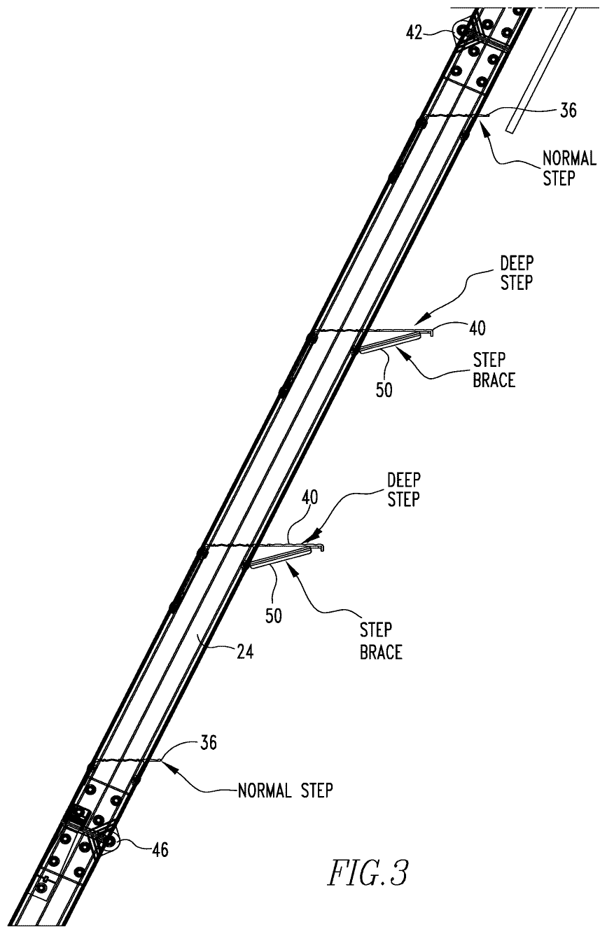

The deep step 40 may be fixed in place between the second right rail and the second left rail. As shown in FIGS. 3 and 5, the ladder 10 may include a first brace or first arm 50 which extends from a rear of the deep step 40 that is located behind the second right rail and the second left rail, to the second right rail to transfer loads on the deep step 40 to the second right rail. The ladder 10 may include a second brace or second arm 52 which extends from the rear of the deep step 40 to the second left rail to transfer loads on the deep step 40 to the second left rail.

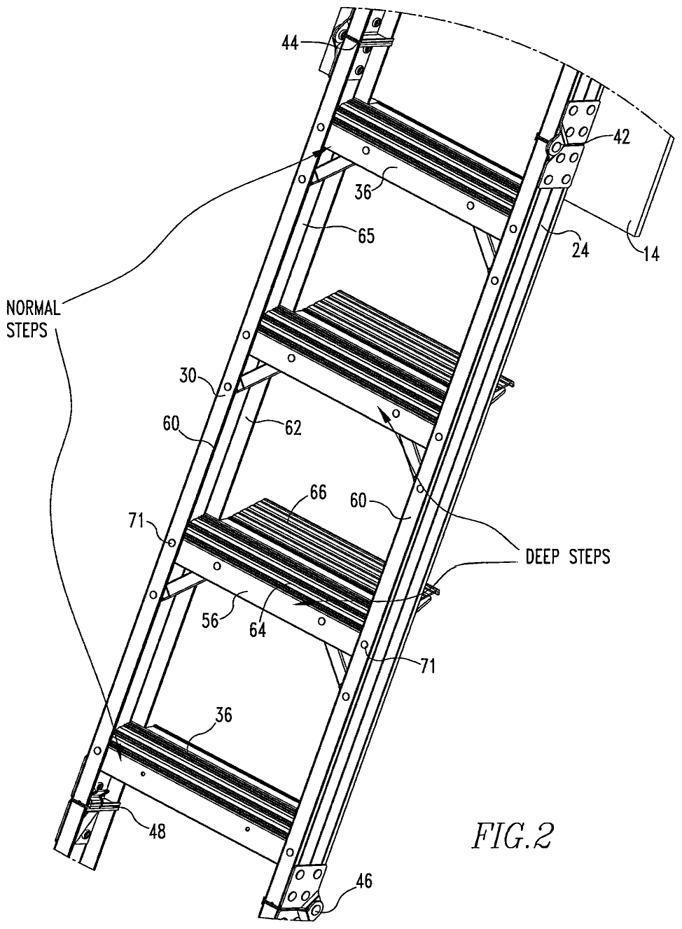

The deep step 40 may be a one-piece extrusion that has a first flange or first skirt 54 whose right side 58 is fastened to and inside of a front flange 60 of the second right rail and whose left side 59 is fastened to an inside of a front flange 60 of the second left rail, as shown in FIGS. 2 and 5. The one-piece extrusion may have a front horizontal portion that extends essentially at a right angle from a top of the first flange 54, a second flange or second skirt 56 which extends essentially at a right angle down from the front horizontal portion and whose right side 58 is fastened to an inside of a rear flange 62 of the second right rail and whose left side is fastened to an inside of a rear flange 62 of the second left rail, as shown in FIGS. 3, 4B and 5. The extrusion may have a rear horizontal portion 66 that extends from the first horizontal portion 64 in a coplanar manner and from the rear flange 62 and essentially at a right angle, and between and behind the second right rail and the second left rail, with the rear horizontal portion 66 having a length which is shorter than a length of the front horizontal portion and a length of the second flange 56.

The deep step 40 may have a lip 68 which extends down from the rear of the rear horizontal portion 66. The first brace 50 may be attached to the second flange 56 and the rear horizontal portion 66 adjacent to the second right rail, and the second brace 52 is attached to the second flange 56 and the rear horizontal portion 66 adjacent the second left rail, with the lip 68 covering over where the first and second braces 50, 52 attached to the rear horizontal portion 66.

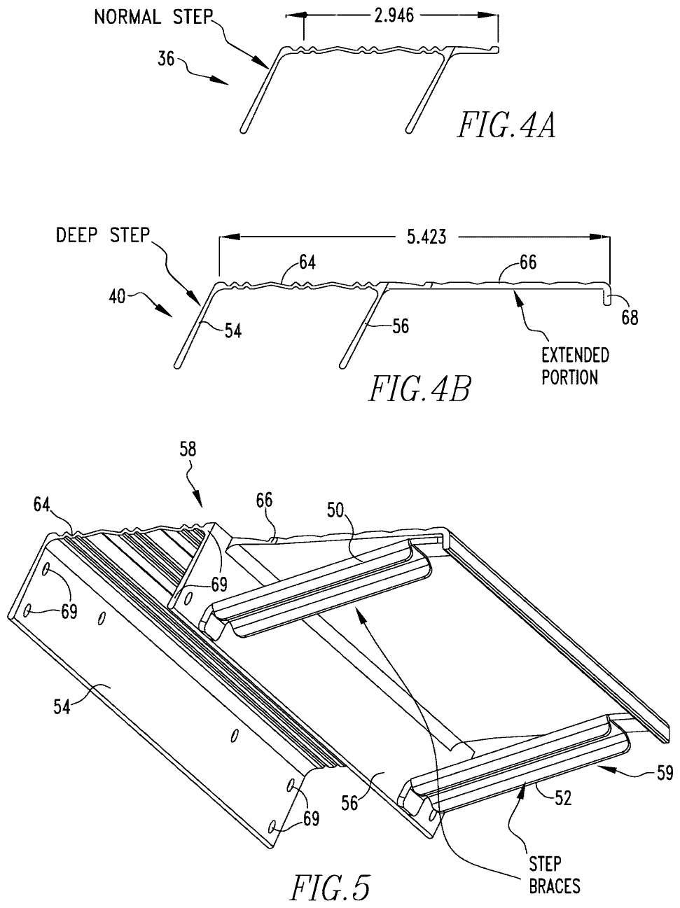

For a normal step, as shown in FIG. 4A, the standard width is between 2.5 inches and 3.25 inches and preferably 2.946 inches. For the deep step 40, as shown in FIG. 4B, the width is between 4.5 inches and 6.5 inches, and preferably 5.423 inches. The deep step 40 can support at least 300 lbs. and is made of aluminum. The front horizontal portion and the rear horizontal portion 66 can have grooves to provide further traction for a user standing on the deep step 40. The thickness of the deep step 40 is between 1/16 inch and ¼ inch and preferably about ⅛ inch. The rear horizontal portion 66 has a shorter length than the front horizontal portion so that it can extend between and through the second right rail and the second left rail. The front flange 60 and the rear flange 62 of the deep step 40 have fastener holes through which fasteners, such as rivets, are inserted to fix the deep step 40 to the second right rail and the second left rail. The braces may be welded or brazed or soldered to the rear flange 62 and the rear horizontal portion 66. Bracket 73, as shown in FIG. 1 and FIG. 6, fix the top section 16 to the door 14, as is well known in the art.

The present invention pertains to a deep step 40 for a ceiling ladder 10, as shown in FIGS. 1, 3, 4B and 5. The ceiling ladder 10 having a plurality of sections with a top section 16 rotatably attached to the ceiling and a second section 18 rotatably attached to the top section 16. The second section 18 having a plurality of steps attached to a second right rail and a second left rail of the second section 18, with the deep step 40 being one of the plurality of steps. The deep step 40 preferably is one-piece, and is preferably an aluminum extrusion, but could also be made of plastic, comprising a first flange 54 whose right side 58 is fastened to and inside of a front flange 60 of the second right rail and whose left side is fastened to and inside of a front flange 60 of the second left rail. The one-piece extrusion comprises a front horizontal portion that extends essentially at a right angle from a top of the front flange 60. The one-piece extrusion comprises a second flange 56 which extends essentially at a right angle down from the front horizontal portion and whose right side 58 is fastened to an inside of a rear flange 62 of the second right rail and whose left side is fastened to an inside of a rear flange 62 of the second left rail. The one-piece extrusion comprises arear horizontal portion 66 that extends from the front horizontal portion in a coplanar manner and from the second flange 56 at essentially a right angle, and between and behind the second right rail and the second left rail, with the rear horizontal portion 66 having a length which is shorter than a length of the front horizontal portion and a length of the second flange 56.

The present invention pertains to a method for placing objects above a ceiling 11 from a floor 15. The method comprises unfolding a plurality of sections of a ladder 10 having steps, which is attached to the ceiling 11, so a user can climb the ladder 10 to above the ceiling 11 from the floor 15. There is the step of a user climbing the ladder 10 and standing on a deep step 40 of the ladder 10 with an object, which is located between about 2 feet and 5 feet above the floor and below the ceiling. The deep step 40 having a width that is at least 1.5 inches longer than a width of other steps of the ladder 10. There is the step of the user placing the object above the ceiling while standing on the deep step 40. There is the step of the user climbing down off the ladder 10 onto the floor. There is the step of the user folding the sections of the ladder 10 together into a retracted position. There is the step of moving the sections of the ladder 10 in the folded position above the ceiling.

FIG. 1 shows a perspective view of an open and fully extended ceiling ladder 10. Typically, attic or ceiling ladders 10 have a frame 12, a door 14 hinged to the frame 12 and ladder sections which are connected to each other by hinges. In this case, there is an upper or top section 16, mid or second section 18 and lower or third section 20. It should be noted that the ladder 10 may only have two sections, the top and the second sections.

FIG. 2 shows a close-up of the second section 18 of the ladder 10. The first and fourth steps of this section are normal steps 36 while the second and third steps are deep steps 40. Users over a wide range of heights are most likely to pause and stand one or the other of those two deep steps 40 while lifting articles up into or down from the attic.

FIG. 3 shows a side view of the second section 18 of the ladder 10. The difference in depth between a normal step 36 and a deep step 40 is apparent. A deep step 40 allows the user to have a larger portion of their “footprint” supported by the step. Also, the deeper step allows the user to maintain solid footing while swiveling left or right as needed when passing containers to or from the attic.

FIGS. 4A and 4B are a comparison of the size and shape of a normal step 36 and a deep step 40. The ladder 10 steps shown are made from aluminum extrusions. The deep step 40 could be made from a single extrusion having an extended portion as shown. Alternately, the extended portion could be a separate piece of material permanently fastened to a normal step extrusion.

FIG. 5 shows step braces fastened to the underside of the deep steps 40. These braces support the extended portion, also referred to here as the rear horizontal portion 66 of the deep step 40.

FIG. 6 shows the ceiling ladder 10 with its top (upper), second (mid), and third (lower) sections folded up prior to closing the door 14. The steps on all three sections are spaced and positioned so that the deep steps 40 will not run into the normal steps 36 when the sections are folded. Because of this, the overall size of the folded ceiling ladder 10, and thus the shipping size of the product package, has not increased due to the presence of deep steps 40.

When folding the ladder 10 into the folded position, the user would lift the second and third sections so the second section rotates about the first hinge 42 and the second hinge 44 clockwise tour word and over the top section 16 and the third section 20 is rotated around the third hinge 46 ¼ inch 48 counterclockwise toward the underside of the second section 18 until the rails of the third section 20 contact the rails of the second section 18 and the third section 20 is on top of the second section 18 as the rails of the second section 18 contact the rails of the top section 16, forming a rectangular shaped sandwich, as shown in FIG. 6.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1.-6. (canceled)

7. A ceiling ladder comprising:
a frame adapted to fit into a ceiling;
a door that fits into the frame;
a top section coupled to the frame, the top section coupled to the door and having a first right rail, a first left rail in parallel with the first right rail, and a plurality of first steps coupled to the first right rail and the first left rail; and
a second section rotatably coupled to the top section, the second section having a second right rail, a second left rail in parallel with the second right rail, and a plurality of second steps coupled to the second right rail and the second left rail, the plurality of second steps including a normal step and a deep step, the normal step disposed entirely within a footprint of the second right rail and the second left rail, the deep step having a first portion disposed within the footprint of the second right rail and the second left rail and a second portion projecting beyond the footprint of the second right rail and the second left rail, a first brace coupled to the deep step, wherein at least a portion of the first brace is coplanar with a portion of the deep step, a second brace coupled to the deep step and at least a portion of the second brace is coplanar with a portion of the deep step.

8. The ceiling ladder of claim 7, wherein the second portion projects beyond the footprint of the second right rail and the second left rail by at least about 1.5 inches.

9. The ceiling ladder of claim 7, wherein the first portion of the deep step includes a first standing surface with a first flange and a second flange depending from the first standing surface, and wherein the second portion of the deep step includes a second standing surface that is coplanar with the first standing surface, the second portion having a proximal edge coupled to the first portion, a distal edge opposite the proximal edge, a first side edge, and a second side edge opposite the first side edge.

10. The ceiling ladder of claim 9, wherein the first brace extends from the second flange to the distal edge of the second portion, the first brace disposed adjacent to the first side edge.

11. The ceiling ladder of claim 10, wherein the second brace extends from the second flange to the distal edge of the second portion, the second brace disposed adjacent to the second side edge.

12. The ceiling ladder of claim 11, wherein the distal edge of the second portion includes a lip depending therefrom, the first brace and the second brace engaging the lip of the second portion.

13. The ceiling ladder of claim 9, wherein the second standing surface and the second flange of the first portion form an obtuse angle.

14. The ceiling ladder of claim 7, wherein the first right rail is connected by a first hinge to the second right rail and the first left rail is connected to the second left rail by a second hinge such that the second section can fold onto the top section in a folded position and unfold from the top section in an unfolded position.

15. The ceiling ladder of claim 14, wherein the deep step is positioned between about 2 feet to 5 feet below the ceiling when the ceiling ladder is in the unfolded position.

16. The ceiling ladder of claim 14, further comprising:
a third section rotatably attached to the second section, the third section having a third right rail, a third left rail in parallel with the third right rail, and a plurality of third steps coupled to the third right rail and third left rail, and wherein the second right rail is connected by a third hinge to the third right rail and the second left rail is connected to the third left rail by a fourth hinge such that the third section can fold onto the second section in the folded position with the top section, the second section, and the third section disposed above the ceiling.

17. The ceiling ladder of claim 14, wherein the door closes into the frame in the folded position.

18. The ceiling ladder of claim 7, wherein the first portion and the second portion of the deep step are made from a single piece of material.

19. The ceiling ladder of claim 7, wherein the deep step can support at least 300 pounds.

20. A ceiling ladder having a plurality of sections, the plurality of sections including:
a top section having a first right rail, a first left rail in parallel with the first right rail, and a plurality of first steps coupled to the first right rail and the first left rail; and
a second section rotatably coupled to the top section, the second section having a second right rail, a second left rail, and a plurality of steps disposed between the second right rail and the second left rail, wherein the plurality of steps includes a deep step, the deep step defining a lengthwise direction that extends from the second right rail to the second left rail and a crosswise direction that extends perpendicular to the lengthwise direction, the deep step having a cross-sectional profile when viewed perpendicular to the lengthwise direction that is different from a cross-sectional profile of other ones of the plurality of steps, the cross-sectional profile of the deep step extending beyond the second right rail and the second left rail in the crosswise direction, the deep step forming a planar standing surface, a flange depending from the planar standing surface, a first brace coupled to the flange adjacent to the second right rail and a second brace coupled to the flange adjacent to the second left rail, wherein at least a portion of the first brace is coplanar with a portion of the deep step and wherein at least a portion of the second brace is coplanar with a portion of the deep step.

21. The ceiling ladder of claim 20, wherein the deep step further includes a lip that depends from the planar standing surface on a portion of the deep step that extends beyond the second right rail and the second left rail, and wherein the first brace and the second brace engage the lip.

22. A ceiling ladder comprising a frame adapted to fit into a ceiling and at least one section including:
a right rail having a first right flange, a second right flange, and a right web extending therebetween;
a left rail having a first left flange, a second left flange, and left web extending therebetween; and
a plurality of steps disposed between the right rail and the left rail, the plurality of steps including a deep step positioned between about 2 feet and about 5 feet from the frame, the deep step defining a lengthwise direction that extends from the right rail to the left rail and a crosswise direction that extends perpendicular to the lengthwise direction, the deep step having a cross-sectional profile when viewed perpendicular to the lengthwise direction that is different other ones of the plurality of steps, the cross-sectional profile of the deep step extending beyond the right rail and the left rail in the crosswise direction, the deep step forming a planar standing surface, a flange depending from the planar standing surface that is coupled to the first left flange and the first right flange, a first brace coupled to the flange adjacent to the right web and a second brace coupled to the flange adjacent to the left web.

23. The ceiling ladder of claim 22, wherein the first brace and the second brace are coupled to a portion of the deep step that extends beyond the right rail and the left rail.

24. The ceiling ladder of claim 23, wherein the deep step further includes a lip that depends from the planar standing surface on the portion of the deep step that extends beyond the right rail and the left rail, and wherein the first brace and the second brace engage the lip.

25. The ceiling ladder of claim 24, wherein the first brace includes a first portion that is coplanar with and coupled to the flange and a second portion that is coplanar with and coupled to the planar standing surface.

26. The ceiling ladder of claim 24, wherein the second brace includes a first portion that is coplanar with and coupled to the flange and a second portion that is coplanar with and coupled to the planar standing surface.
